(19) United States
(12) Patent Application Publication
(10) Pub. No.: US 2021/0237059 A1
(43) Pub. Date: Aug. 5, 2021

(54) MICROFLUIDIC DEVICES WITH IMPEDANCE SETTING TO SET BACKPRESSURE

(71) Applicant: HEWLETT-PACKARD DEVELOPMENT COMPANY, L.P., Spring, TX (US)

(72) Inventors: Daryl E. Anderson, Corvallis, OR (US); James Michael Gardner, Corvallis, OR (US); Eric Martin, Corvallis, OR (US)

(73) Assignee: HEWLETT-PACKARD DEVELOPMENT COMPANY, L.P., Spring, TX (US)

(21) Appl. No.: 17/049,302

(22) PCT Filed: Aug. 9, 2018
(86) PCT No.: PCT/US2018/046082

§ 371 Date: Oct. 20, 2020

(51) Int. Cl. B01L 3/00

(52) U.S. Cl. CPC B01L 3/502715; B01L 2300/0636; B01L 2300/0816; B01L 2400/0688; B01L 2400/0439; B01L 2400/0442; B01L 2400/0487; B01L 2400/0406

(57) ABSTRACT

A microfluidic device may include a fluid channel defined in a substrate, an impedance sensor positioned within the fluid channel, and control logic. The control logic may force a current into the impedance sensor to sense an impedance at the location of the impedance sensor, the sensed impedance defining whether the fluid within the fluid channel is at the location of the impedance sensor, and instruct a pump device to apply a back pressure on the fluid to maintain the fluid upstream from the impedance sensor in response to a determination that the sensed impedance indicates that the fluid is located at the location of the impedance sensor.

### BACKGROUND

Microfluidics, as it relates to the sciences, may be defined as the manipulation and study of minute amounts of fluids, and microfluidics devices may be used in a wide range of applications within numerous disciplines such as engineering, physics, chemistry, biochemistry, nanotechnology, and biotechnology along with other practical applications. Microfluidics may involve the manipulation and control of small volumes of fluid within various systems and devices such as lab-on-chip devices, printheads, and other types of microfluidic chip devices.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a microfluidic device, according to an example of the principles described herein.

FIGS. 2A through 2C are block diagrams of a microfluidic device depicting a fluid at various locations within a passageway, according to an example of the principles described herein.

FIG. 3A is a block diagram of a microfluidic device including sensors to detect single, dual, or differential impedance sense, according to an example of the principles described herein.

FIG. 3B is a block diagram of a microfluidic device including sensors to detect a high change of on/off resistance, according to an example of the principles described herein.

FIG. 3C is a block diagram of a microfluidic device including sensors to detect a flow rate, according to an example of the principles described herein.

FIGS. 4A through 4C are block diagrams of a microfluidic device depicting a fluid at various locations within a passageway, according to an example of the principles described herein.

FIG. 5A is a block diagram of a microfluidic device including sensors to detect single, dual, or differential impedance sense, according to an example of the principles described herein.

FIG. 5B is a block diagram of a microfluidic device including sensors to detect a boundary of fluid within a passageway of the microfluidic device, according to an example of the principles described herein.

FIG. 6A is a block diagram of a microfluidic device, according to an example of the principles described herein.

FIG. 6B is a block diagram of a microfluidic device including an extended sensor, according to an example of the principles described herein.

FIG. 7 is a flowchart showing a method of controlling movement of a fluid within a microfluidic device, according to an example of the principles described herein.

FIG. 8 is a flowchart showing controlling a movement of a fluid within a microfluidic device, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Microfluidic devices may enable manipulation and control of small volumes of fluid through microfluidic fluidic channels or networks of the microfluidic devices. For example, microfluidic devices may enable manipulation and/or control of volumes of fluid on the order of microliters (i.e., symbolized μl and representing units of 10⁻⁶ liter), nanoliters (i.e., symbolized nl and representing units of 10⁻⁹ liter), or picoliters (i.e., symbolized pi and representing units of 10⁻¹² liter). Thus, microfluidic devise process low volumes of fluids to achieve multiplexing, automation, and high-throughput screening.

Microfluidic devices employ sensors such as, for example, biosensors, bioelectrical sensors, cell-based sensors, and other sensors that provide point of care diagnostics for medical diagnostics, food analysis, environmental monitoring, drug screening and other point of care applications. Cell-based sensor apparatus, for example, detect or measure cellular signals from living cells of a sample fluid to identify, for example, a specific species of bacteria, virus and/or disease. In operation, as the fluid flows adjacent, past or across the sensors such as electrodes, the sensors detects or converts signals detected in the fluid to electrical signals that are analyzed to determine or identify a characteristic of the fluid detected by the sensor. For example, the sensors may employ an electrode positioned in a fluidic channel or a sensor chamber, and an interaction between the fluid and a surface of the electrode may be monitored by applying a small amplitude alternating current (AC) electric field. In some examples, the fluid has a different impedance versus empty space with air present, and the difference in impedance of the fluid versus the air alters the electric field produced by the electrode.

In microfluidic systems, such as lab-on-chip (LOC) designs for molecular diagnostics, it may be desirable to accurately and precisely control the movement of fluids within the various passageways within a microfluidic device and position the fluid or an edge of the fluid accurately and precisely within the passageways within the microfluidic device. Providing such control in the microfluidic device allows for a larger number of physical and chemical processes to be performed on the fluid. For example, accurately and precisely control the movement of a fluid within a micro-reaction (μ-reaction) chamber may allow the user to ensure that any reactions taking place in the μ-reaction chamber run their course and are completed before the fluid is allowed to leave the μ-reaction chamber to be moved into another passageway for further processing, testing, and sensing.

The accurate and precise control of the movement of fluids within the various passageways within a microfluidic device may be achieved through the use of a number of impedance sensors located within the passageways. These impedance sensors are capable of detecting the presence of different fluids such as air and any number of analyte solutions at locations within the passageways at which those impedance sensors are located based on the impedance values sensed. The impedance values obtained from these sensors may be used by control logic to determine where the fluids are located within the passageways and, with the control logic, activate a number of internal or external pump devices to create a pressure differential within the passageways to retain the fluid at a desire position or location within the passageways. In this manner, the impedance sensors and the pumps create a feedback loop in which detection and correction of the position of the fluids may be achieved. Without a feedback system like that described herein, microfluidic devices would otherwise use simple measurements of backpressure at the microfluidic device level without the accuracy and precision provided by the impedance sensors located at numerous positions within the actual passageways of the microfluidic device. Further, unlike the closed-looped pressure differential setting provided by the impedance sensors, pumps, and control logic described herein, the system would otherwise rely on open-looped backpressure setting where the actual location within the microfluidic device is not known, and the system would be blind as to where the fluids are actually located. The devices, systems, and methods described herein utilize the impedance sensors located in the various microfluidic passageways to sense in real time the positioning of the fluids using electrical impedance measurements. With a closed-loop feedback system as described herein, the fluids, and, specifically, the boundaries between the fluids and air, may be brought to a specific location, and maintained at that location.

Examples described herein provide a microfluidic device including a fluid channel defined in or above a substrate, an impedance sensor positioned within the fluid channel, and control logic. The control logic forces a current into the impedance sensor to sense an impedance at the location of the impedance sensor, the sensed impedance defining whether the fluid within the fluid channel is at the location of the impedance sensor, and instructs a pump device to apply a back pressure on the fluid to maintain the fluid upstream from the impedance sensor in response to a determination that the sensed impedance indicates that the fluid is located at the location of the impedance sensor.

In an example, the impedance sensor includes a first impedance sensor located at a first location within the fluid channel of the microfluidic device, and a second impedance sensor located at a second location within the fluid channel downstream relative to the first impedance sensor. The control logic instructs the pump device to allow the fluid to move past the first impedance sensor but not past the second impedance sensor based on the detection of the fluid by the first impedance sensor and the second impedance sensor.

In an example, the impedance sensor includes a single impedance sensor including a conductive plate with a length of at least a portion of the fluid channel, and wherein the single impedance sensor, when actuated to measure an impedance value, provides an analog signal that correlates with an amount of fluid within the fluid channel, the amount of fluid defining the location within the fluid channel at which the fluid is present. Instructing the pump device to apply a back pressure on the fluid to maintain the fluid upstream from the impedance sensor in response to a determination that the sensed impedance indicates that the fluid is located at the location of the impedance sensor includes, with the pump device, drawing the fluid upstream within the fluid channel until the sensed impedance of the impedance sensor indicates that the fluid is not in contact with the impedance sensor and is upstream from the impedance sensor.

The microfluidic device continually or periodically monitors the sensed impedance at the impedance sensor to determine if the sensed impedance at the impedance sensor has changed. The microfluidic device may periodically cycle the backpressure provided by the pump device such that the fluid contacts the impedance sensor and drawing the fluid upstream within the fluidic channel.

Examples described herein also provide a system for applying back pressure within a microfluidic device. The system includes a fluid detection array including at least one impedance sensor located within a fluid channel of the microfluidic device, a pump device to move the fluid within the fluid channel, and control logic. The control logic forces a current into the impedance sensor to sense an impedance at the location of the impedance sensor, the sensed impedance defining whether the fluid within the fluid channel is at the location of the impedance sensor, and instruct the pump device to apply a back pressure on the fluid to maintain the fluid upstream from the impedance sensor in response to a determination that the sensed impedance indicates that the fluid is located at the location of the impedance sensor.

The fluid detection array includes a first impedance sensor located at a first location within the fluid channel of the microfluidic device, and a second impedance sensor located at a second position within the fluid channel downstream relative to the first impedance sensor. In an example, the control logic instructs the pump device to allow the fluid to move past the first impedance sensor but not past the second impedance sensor based on the detection of the fluid by the first impedance sensor and the second impedance sensor. In an example, the impedance sensor includes a single impedance sensor including a conductive plate with an aspect ratio of the fluid channel, and wherein the single impedance sensor, when actuated, provides an analog signal that correlates with an amount of fluid within the fluid channel, the amount of fluid defining the location within the fluid channel at which the fluid is present.

The control logic, with the pump device, draws the fluid upstream within the fluid channel until the sensed impedance of the impedance sensor indicates that the fluid is not in contact with the impedance sensor and is upstream from the impedance sensor. The control logic continually or periodically monitors the sensed impedance at the impedance sensor to determine if the sensed impedance at the impedance sensor has changed. The control logic periodically cycles the backpressure provided by the pump device such that the fluid contacts the impedance sensor and draws the fluid upstream within the fluidic channel.

Examples described herein also provide a method of controlling movement of a fluid within a microfluidic device. The method may include forcing a current into a fluid detection array including at least one impedance sensor located within a fluid channel of the microfluidic device to sense whether a fluid is present within the fluid channel at the location of the at least one impedance sensor, and, in response to detecting the fluid at the impedance sensor, applying a back pressure on the fluid to draw the fluid upstream until the impedance sensor detects the fluid has been drawn upstream relative to the impedance sensor.

The method may include periodically cycling the backpressure such that the fluid contacts the impedance sensor and is drawn upstream within the fluidic channel. Further, the method may include, in response to an instruction to allow the fluid to move downstream relative to the impedance sensor, removing or reducing the backpressure to allow the fluid to travel past the impedance sensor, and detecting with the impedance sensor, whether the fluid is present within the fluid channel at the location of the impedance sensor.

As used in the present specification and in the appended claims, the term “passageway” is meant to be understood broadly as any void within a die of a microfluidic device into which a fluid may be introduced. A passageway may include a reservoir, a micro-reaction (μ-reaction) chamber, a fluidic channel, a retention chamber, a drain chamber, a nozzle chamber, other passageways, and combinations thereof.

As used in the present specification and in the appended claims, the terms “passive” in the context of priming passageways within a microfluidic device is meant to be understood broadly as any process used to prime the passageways that does not use the application of a pressure differential applied to an end of the passageway to move the fluid through the passageway. In one example, passive priming of the passageway may be achieved through capillary forces where a fluid flows in the passageways without the assistance of, or even in opposition to, external forces such as gravity. Capillary action occurs because of intermolecular forces between the fluid and surrounding solid surfaces such as the interior surfaces of the passageways defined within the microfluidic device. If the diameter or cross-section of the passageways are sufficiently small, then the combination of surface tension caused by cohesion within the fluid and adhesive forces between the fluid and the walls of the passageways act to propel the fluid.

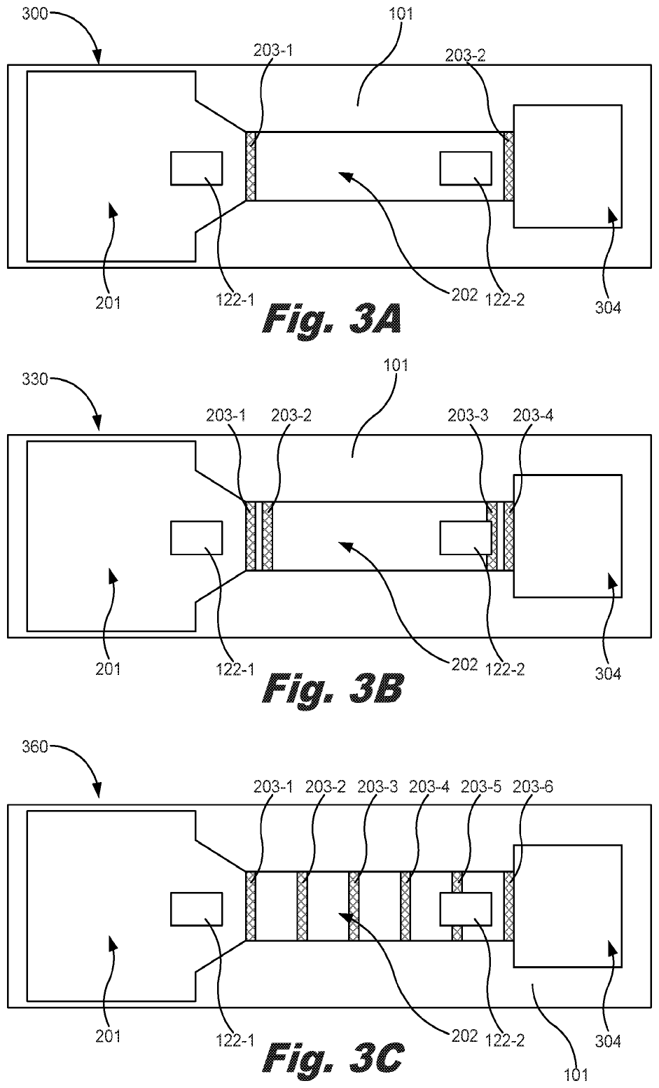

As used in the present specification and in the appended claims, the terms “active” in the context of priming passageways within a microfluidic device is meant to be understood broadly as any process used to prime the passageways that uses the application of a pressure differential applied to the fluid to move the fluid through the passageway. In one example, active priming of the passageway may be achieved through activation of a pump device. The pump devices may include inertial pumps that include thermal resistive elements or piezoelectric elements, or external pump devices that are fluidically coupled to an end of the passageway such as the reservoir (201), the nozzle chamber (204), or terminating chamber (FIGS. 3A-3C, 304) to create a positive or negative pressure within the passageways to move the fluid through the passageways.

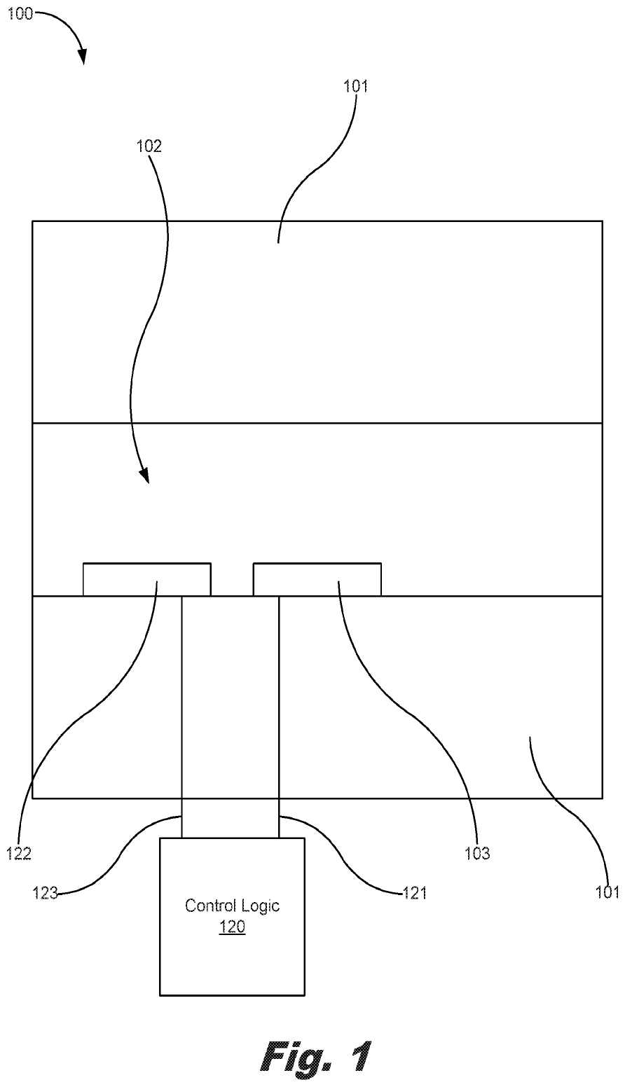

Turning now to the figures, FIG. 1 is a block diagram of a microfluidic device (100), according to an example of the principles described herein. The elements of the microfluidic devices and their functions and purposes described herein may be used in any type of microfluidic device including, for example, assay systems, point of care systems, and any systems that involve the use, manipulation, control of small volumes of fluid, and combinations thereof. For example, the microfluidic device (100) may incorporate components and functionality of a room-sized laboratory or system to a small chip such as a microfluidic biochip or “lab-on-chip” (LOC) that manipulates and processes solution-based samples and systems by carrying out procedures that may include, for example, mixing, heating, titration, separation, other chemical and physical processes, and combinations thereof. For example, the microfluidic device (100) may be used to integrate assay operations for analyzing enzymes and DNA, detecting biochemical toxins and pathogens, diagnosing diseases, viruses, and bacteria, other chemical and biochemical processes, and combinations thereof.

The microfluidic device (100) may include a die (101) with at least one microfluidic passageway (102) defined therein. The die (102) may be made of, for example, silicon (Si). In an example, the die (101) may include a plurality of microfluidic passageways (102) defined therein in any configuration and architecture to provide for the movement, mixing, and reacting of fluids within the microfluidic device (100). The microfluidic passageways (102) may include fluidic inlets, reservoirs, chambers, reactors, reaction cites, junctions, channels, capillary breaks, outlets, nozzles, venting ports, drains, and other architectures for use in accomplishing the desired chemical and physical processes of the microfluidic device (100).

At least one impedance sensor (103) is located within a microfluidic passageway (102) of the microfluidic device (100). In one example, the impedance sensor (103) may be located at an orifice within a fluidic channel of the microfluidic device (100). The at least one impedance sensor (103) may be any device that can sense an impedance value of a fluid within the microfluidic passageways (102). In one example, the impedance sensor (103) may be an electrode electrically coupled to a voltage or current source. The electrode may be a thin-film electrode formed on an interior surface of the microfluidic passageways (102) defined within the die (101) of the microfluidic device (100). In an example, a current may be applied to the impedance sensor (103) when a position of a fluid within the microfluidic passageway (102) is to be detected, and a voltage may be measured. In another example, a voltage may be applied to the impedance sensor (103) when the position of the fluid within the microfluidic passageway (102) is to be detected, and a current may be measured. In an example, the impedance sensors (103) described herein may include a tantalum (Ta) sensor plate electrically coupled to control logic (120) by an electrical line (121).

In an example, the impedance sensors (103) may positioned throughout the microfluidic device (100) where they may contact a fluid that is subjected to testing within the microfluidic device (100). Placing impedance sensors (103) near the fluidic inlets and outlets allows for the microfluidic device (100) to confirm a movement of the fluid in the passageways of the microfluidic device (100), or a reservoir depletion during micro-titration or other physical and chemical processes preformed on the fluid. Further, placing impedance sensors (103) throughout the microfluidic device (100) provides for in-situ fluid position monitoring and trapped air detection that may be remedied through intervention by the microfluidic device (100).

The control logic (120) may be used to send electrical signals to the impedance sensors (103), receive detected impedance values at the sensors (103), activate a number of internal or external pumps (122) to control the location of the fluid within the passageways of the microfluidic device (100) based on feedback from the sensors (103), activate a number of measurement devices to measure a characteristic or property of the fluid, perform other processes, and combinations thereof. Throughout the present description, the control logic (120) may be coupled to any device within the microfluidic device (100) including impedance sensors (103) and pumps (122) to control the activation of these devices and the receipt of date from the devices. In one example, to measure the impedance at the impedance sensors (103), a small current may be forced into the impedance sensors (103), and a resulting voltage may be measured after a predetermined amount of time. In this example, if the impedance sensors (103) are not in contact with the fluid (i.e., air is surrounding the impedance sensors (103)), the impedance measured may be relatively high compared to if the impedance sensors (103) are in contact with fluid where the impedance measured will be relatively much lower.

In the example where a fixed current is applied to the fluid surrounding the at least one impedance sensor (103), a resulting voltage may be sensed. The sensed voltage may be used to determine an impedance of the fluid, whether it be air or another fluid such as an analyte, surrounding the at least one impedance sensor (103) at that area within the microfluidic passageway (102) at which the at least one impedance sensor (103) is located. Electrical impedance is a measure of the opposition that the circuit formed from the at least one impedance sensor (103) and the fluid presents to a current when a voltage is applied to the impedance sensor (103), and may be represented as follows:

$$Z = \frac{V}{I} \qquad Eq . 1$$

where Z is the impedance in ohms (Ω), V is the voltage applied to the impedance sensor (103), and I is the current applied to the fluid surrounding the impedance sensor (103). In another example, the impedance may be complex in nature, such that there may be a capacitive element to the impedance where the fluid may act partially like a capacitor. For complex impedances, the current applied to the impedance sensor (103) may be applied for a particular period of time, and a resulting voltage may be measure at the end of that time.

The detected impedance (Z) corresponds to an impedance value of the fluid; whether that fluid is air or another fluid being moved into or within the microfluidic passageway (102). Stated in another way, the impedance (Z) corresponds to, for example, a dispersion level of the particles, ions, or other chemical and physical properties of the fluids. In one example, if the impedance detected at the impedance sensors (103) is relatively higher, this may indicate that the fluid has a higher impedance in that area at which the impedance is detected. This relatively higher impedance may indicate that the fluid surrounding the impedance sensor (103) is air which, in many cases, may have a higher impedance relative to other fluids such as analytes, solvents, and other chemical solutions. Conversely, a relatively lower impedance within that portion of the fluid may indicate that the fluid surrounding the impedance sensor (103) is a fluid other than air which, in many cases, may have a lower impedance relative to the other fluids such as analytes, solvents, and other chemical solutions. In this manner, it may be determined that a fluid other than air has not yet made it to that impedance sensor (103) and at least that portion of the microfluidic passageway (102). In one example, the fluid may be allowed to move further down the microfluidic passageway (102) or may be retained at a position within the microfluidic passageway (102) depending on what the chemical or physical process is being performed within the microfluidic passageway (102). In some examples, it may be desirable to keep the non-air fluid from entering or traveling downstream within the microfluidic passageway (102) for an amount of time, and then allow the fluid to move further down the microfluidic passageway (102) at a later time.

The control logic (120) of FIG. 1 may be any combination of hardware and computer-readable program code that is executed to force a current into the impedance sensors (103) to sense the presence of a fluid within the microfluidic passageway (102) at the locations of the impedance sensors (103). The control logic (120) also determines if the non-air fluid is present within the microfluidic passageway (102) based on the impedance values sensed by the impedance sensors (103). The presence of the fluid within at least a portion of the microfluidic passageways (102) of the microfluidic device (100) may be tracked based on sensed impedance at the impedance sensors (103) that is relayed to the control logic (120). Processing devices within or external to the control logic (120) may be used to analyze the sensed impedances and determine a position of the fluid within the microfluidic passageway (102) of the microfluidic device (100).

Further, the control logic (120) may monitor for at least a second time or instance, the impedance sensed at the impedance sensors. As the fluid passively or actively flows into the microfluidic passageway (102), it may be desirable to ascertain the progress of the fluid within the microfluidic passageway (102) and to determine a flow rate of the fluid using a plurality of impedance sensors (103). Still further, the control logic (120) may determine if the impedance sensors (103) detect the absence of fluid in microfluidic passageway (102) once the fluid has been detected within the microfluidic passageway (102). The absence of the fluid indicates that the fluid has not yet reached that impedance sensor (103) or that a portion of the fluid has passed the impedance sensor (103) and the impedance sensor (103) is exposed to air in the microfluidic passageway (102) such as in instances when an air bubble is introduced into the microfluidic passageway (102) or a depletion of the fluid that is sourced into the microfluidic passageway (102) from, for example, a reservoir occurs. In this example, the control logic (120) may send an activation signal to a pump device (122) to create a negative pressure within the passageway (102) that draws the fluid back upstream in the microfluidic passageway (102) if it is desired that the fluid not pass that impedance sensor (103).

The control logic (120) may also determine when it is appropriate to allow the fluid to continue to move downstream within the microfluidic passageway (102). In some examples, it may be desirable to restrain the fluid from moving downstream within the microfluidic passageway (102) for a period of time such as in order to allow the fluid to complete a reaction before moving onto other portions of the microfluidic device (100) for further processing. In response to a determination that the waiting period for restraining the fluid within the microfluidic passageway (102) is complete, the control logic (120) may instruct a pump device (122) to reduce or release any negative pressure on the fluid that was restraining the fluid and pump the fluid downstream, or reduce or release any negative pressure on the fluid that was restraining the fluid and allow capillary forces to draw the fluid downstream. The control logic (120) may also instruct other devices to begin additional processing of the fluid within the microfluidic device (100) by activating a number of fluid processing elements within the microfluidic device (100). In an example, the pump device (122) may also be instructed by the control logic (120) to apply a positive pressure on the fluids within the microfluidic passageway (102) to move the fluid downstream.

In the examples described herein, the impedance sensor (103) may include a single impedance sensor. In this example, the single impedance sensor (103) may include a conductive plate with a length of at least a portion of the fluidic channel. The single impedance sensor, when actuated, provides an analog signal that correlates with an amount of fluid within the microfluidic passageways (102). In an example, the single impedance sensor may run the length of a distance between at least two positions within the microfluidic device (100).

In the examples described herein, the control logic (120) may activate an internal pump device (122) and/or an external pump device to move the fluid within the at least one microfluidic passageway (102) in an upstream direction, a downstream direction, and combinations thereof. For example, the control logic (120) may receive a signal from the at least one impedance sensor (103) that defines a sensed impedance at the impedance sensor. If an intended outcome is to ensure that the fluid does not pass that impedance sensor (103) and the sensed impedance indicates that the fluid is located at least at the impedance sensor (103), then the control logic (120) may cause a pump device (122) to increase a negative pressure on the microfluidic passageways (102) to pull the fluid back upstream past the impedance sensor (103). The control logic (120) may receive a sensed impedance from the impedance sensor (103) that indicates that the fluid has passed the impedance sensor (103) back upstream, and the control logic (120) may instruct the pump device (122) to increase a negative pressure sufficient to restrict the fluid form moving past the impedance sensor in the downstream direction again and hold the fluid at its current position.

Further, in an example, the control logic (120) may perform a number of backpressure cycling processes where the control logic (120) instructs the pump device (122) to reduce the backpressure created to restrain the fluid at a point within the microfluidic passageway (102), and either instruct the pump device (122) to move the fluid downstream or allow the fluid to move downstream via capillary forces. In this example, an impedance sensor (103) is used to detect the presence of the fluid at that point within the microfluidic passageway (102). In this cycling processes, once the impedance sensor (103) again detects the fluid after the control logic (120) allows the fluid to move downstream, the impedance signal detected by the impedance sensor (103) may be sent to the control logic (120), and the control logic (120) may instruct the pump device (122) to again apply the backpressure to draw the fluid back upstream past the impedance sensor (103) and hold the fluid at some point upstream of that impedance sensor (103). By cycling the backpressure in this manner, the microfluidic device (100) is able to confirm the location of the fluid within the microfluidic passageway (102). In an example, the backpressure cycling process may be performed any number of times during a period in which the pump device (122) is instructed to apply a restraining backpressure on the fluid. In an example, the control logic (120) may perform the backpressure cycling processes at predetermined intervals of time.

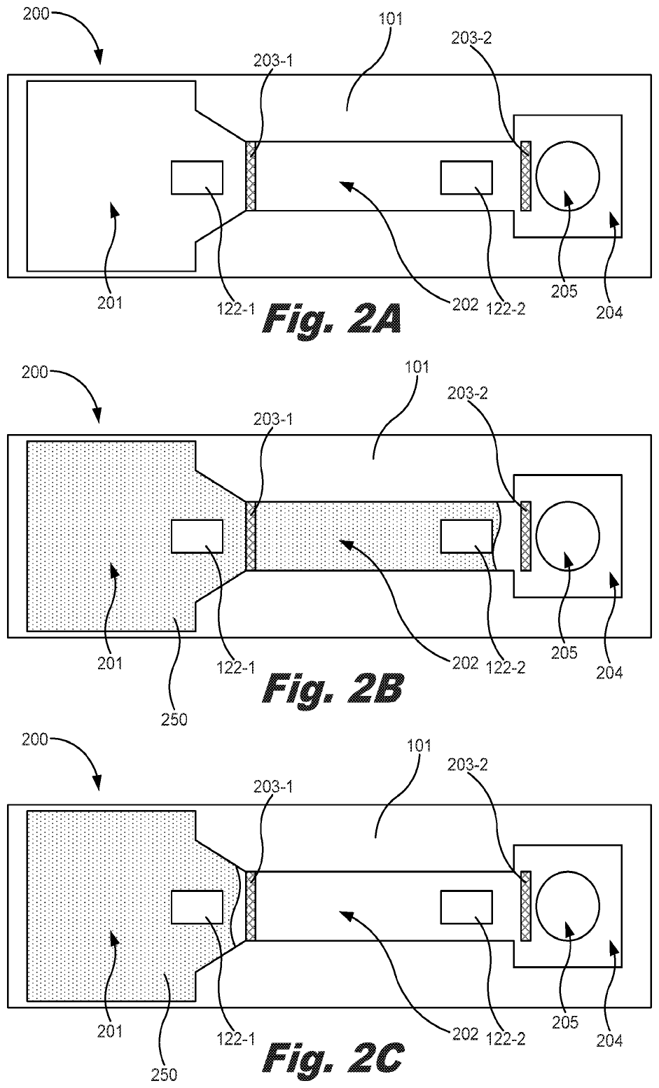

FIGS. 2A through 2C are block diagrams of a microfluidic device (200) depicting a fluid at various locations within a passageway, according to an example of the principles described herein. The microfluidic device (200) of FIGS. 2A through 2C may include any number of fluidic inlets, reservoirs, chambers, reactors, reaction cites, junctions, channels, capillary breaks, outlets, nozzles, venting ports, drains, and other architectures for use in accomplishing the desired chemical and physical processes of the microfluidic device (200). Specifically, the microfluidic device (200) of FIGS. 2A through 2C may include a reservoir (201) into which a fluid (250) to be analyzed within the microfluidic device (200) is placed to allow the fluid (250) to enter other passageways within the die (101) of the microfluidic device (200). A fluidic channel (202) may be fluidically coupled to the reservoir (201) to allow for the conveyance of the fluid (250) toward a nozzle chamber (204). Although a nozzle chamber (204) with a nozzle (205) defined therein is depicted in FIGS. 2A through 2C, a drain or reaction chamber may be the destination of the fluid (250). The nozzle (205) may be used to eject the fluid (250) from the nozzle chamber (204) into another passageway, another microfluidic device, or out of the microfluidic device (200) entirely. In this manner, the reservoir (201), fluidic channel (202), nozzle chamber (204), and nozzle (205) are fluidically coupled to one another, and the fluid may enter these and other architectures of the microfluidic device (200) through passive capillary forces.

The fluid (250) has not been introduced into the reservoir (201) of the microfluidic device (200) at the state depicted in FIG. 2A. However, at the state of the microfluidic device (200) depicted in FIG. 2B, the fluid (250) has been introduced into the reservoir (201), and the fluid (250), through capillary forces or through activation of the pump device (122), has traveled into the fluidic channel (202) past a first impedance sensor (203-1). The first impedance senor (203-1) in FIG. 2A will detect that the fluid (250) is not present at and past the first impedance senor (203-1). Likewise, the second impedance senor (203-2) in FIG. 2A will detect that the fluid (250) is not present at and past the second impedance senor (203-2) or within the nozzle chamber (204). The sensors (203) described throughout the figures will be collectively referred to herein as 203.

In FIG. 2B, the first impedance senor (203-1) will detect the fluid (250) has traveled down the fluidic channel (202) at least as far as the location of the first impedance senor (203-1), but the second impedance senor (203-2) will still detect that the fluid (250) has not reached its position or entered the nozzle chamber (204). Thus, the control logic (100), to which all impedance sensors (203) described herein are electrically and communicatively coupled, will determine that the fluid (250) has entered the fluidic channel (202), and not the nozzle chamber (204), and has traveled to a point in the microfluidic channel (102) between the first impedance sensor (203-1) and the second impedance sensor (203-2). In an example, more impedance sensors (203) may be included within the fluidic channel (202) to determine a more precise location of the fluid's (250) capillary progress within the fluidic channel (202).

In FIG. 2C, the detection of the fluid at the first impedance sensor (203-1) may be relayed to the control logic (120). In instances where the processing of the fluid within the microfluidic device (200) calls for the retention of the fluid upstream from the first impedance sensors (103-1), the control logic (120) may activate the first pump device (122-1). The first pump device (122-1) may then increase a negative pressure causing the fluid to move upstream past the first impedance sensor (203-1). Once the control logic (120), through the first impedance sensor (203-1) sensing the impedance of the fluid and then air, determines that the fluid has been drawn upstream past the first impedance sensor (203-1), the control logic (120) may instruct the first pump device (122-1) to maintain the negative pressure on the fluid at a level at which the fluid does not further move upstream, but remains at a location just upstream from the first impedance sensor (203-1). In this manner, the impedance sensors (203) within the microfluidic devices (200) described herein provide feedback to the control logic (120) to precisely and accurately move fluid through the passageways of the microfluidic devices (200).

A plurality of pump devices (122) and impedance sensors (203) may be included within the microfluidic devices (200). In an example, the pump devices (122) and impedance sensors (203) may be arranged as pairs in order to provide a plurality of positions within the passageways of the microfluidic device (200) at which the fluid may be stopped from moving further down the passageways and retained at those positions.

Further, as described herein, an external pump may be fluidically coupled to either end of the passageway of the microfluidic device (200) to apply positive or negative pressure in addition to or in place of the capillary forces used to move the fluid (250) within the passageways or in addition to or in place of the internal pump devices (122). In this example, the external pump may increase a negative pressure to be placed on the fluid (250) to cause the fluid to stop its movement through the fluidic channel (202) as depicted in FIG. 2B to retain the fluid at the position between the first impedance sensor (203-1) and the second impedance sensor (203-2) for a period of time, or to retain the fluid at the position before the first impedance sensor (203-1) or the second impedance sensor (203-2). In this example, the fluid (250) may be retained at these positions to allow for other physical and chemical reactions to take place within the microfluidic device (200) before the fluid (250) within the microfluidic device (200) is introduced to other portions of the microfluidic device (200).

Further, other devices such as heating devices used to heat the fluid (250), cooling devices used to cool the fluid (250), mixing devices to mix the fluid (250), other devices to change a physical or chemical property of the fluid may also be included within the reservoir (201), fluidic channel (202), nozzle chamber (204), nozzle (205), or any other passageway or architecture of the microfluidic device (200). These additional devices may be included to allow these devices to alter the fluid's (250) physical and/or chemical properties before the fluid is allowed to proceed further within the microfluidic device (200). The internal pumps (122) and the external pump may be used to retain the fluid (250) at a position within the microfluidic device (200) to allow these additional devices to perform their respective functions before the fluid (250) is allowed to proceed within the passageways within the microfluidic device (200).

FIGS. 2A through 2C depict the manner in which the fluid (250) may passively or actively move within the passageways of the microfluidic device (200). Once the fluid is positioned within the passageways of the microfluidic device (200) including, for example, the reservoir (201), fluidic channel (202), nozzle chamber (204), nozzle (205) as detected by the impedance sensors (203-1, 203-2) and as called for in performing the processing and measuring of the fluid, measurements and/or processing of the fluid (250) may take place.

In some examples, impedance sensors (203) may also be able to detect the absence of the fluid (250) before and after an initial detection of the fluid has been made by the one impedance sensor (203). A detection of an absence of the fluid (250) may be the result of an air bubble introduced into the fluid (250) further upstream, or may result from fluid (250) no longer being introduced into the microfluidic device (200) or a complete consumption of an amount of the fluid (250) by the microfluidic device (200). The impedance sensors (230) may continually detect whether the fluid (250) is located at its position in the microfluidic device (200) so that any disrupted flow of the fluid (250) may be detected.

In some examples, at least two impedance sensors (203-1, 203-2) may be used to detect a differential value. For example, in FIG. 2B, the impedance value detected by the first impedance sensor (203-1) may be compared to the value detected by the second impedance sensor (203-2) to determine the location of the fluid (250) within the microfluidic device (200). In FIG. 2B, the first impedance sensor (203-1) may detect a relatively lower impedance value with respect to the impedance value detected by the second impedance sensor (230-2) because the impedance of the fluid (250) surrounding the first impedance sensor (203-1) may have a relatively lower impedance with respect to air which the second impedance sensor (230-2) may be exposed to. This differential value may be used by the control logic (120) to determine that the fluid (250) has passed the first impedance sensor (203-1) but not the second impedance sensor (203-2).

Thus, throughout the examples described herein, in sensing the fluid (250) within the passageways of the microfluidic device (100, 200, 300, 330, 360, 400, 500, 550, 600, 650) in a singular manner, the control logic (120) may simply send a signal to an impedance sensor (203) to detect whether the fluid (203) is located at that impedance sensor (203) irrespective or independent of the inclusion of another impedance sensor (203) within the microfluidic device (100, 200, 300, 330, 360, 400, 500, 550, 600, 650) or the activation of another impedance sensor (203) to sense an impedance at that other impedance sensor (203).

When used as dual sensors (203) including at least two impedance sensors (203), the control logic (120) may send an activation signal to the at least two impedance sensors (203) and an impedance value may be received by the control logic (120) from each of the two or more impedance sensors (203) to determine the position of the fluid (250) within the passageways of the microfluidic device (100, 200, 300, 330, 360, 400, 500, 550, 600, 650).

When a plurality of impedance sensors (203) are used in a differential manner, the control logic (120) may send an activation signal to the plurality of impedance sensors (203) and an impedance value may be received by the control logic (120) from each of the plurality of impedance sensors (203). The impedance values obtained from each of the plurality of impedance sensors (203) may be compared to track a differential signal to determine location of the fluid (250) within the passageways of the microfluidic device (100, 200, 300, 330, 360, 400, 500, 550, 600, 650).

FIG. 3A is a block diagram of a microfluidic device (300) including sensors (203) to detect single, dual, or differential impedance sense, according to an example of the principles described herein. The microfluidic device (300) includes many elements that are included within the microfluidic device (200) of FIGS. 2A through 2C. The microfluidic device (300) of FIG. 3A, and the microfluidic devices (330, 360) of FIGS. 3B and 3C include a terminating chamber (304) that does not include the nozzle (205) of the microfluidic device (200) of FIGS. 2A through 2C. The terminating chamber (304) may serve any number of purposes including acting as a micro-reaction (μ-reaction) chamber where a reaction with another fluid or a material that exists within the terminating chamber (304). The terminating chamber (304) may serve as a drain or repository for waste fluid.

FIG. 3B is a block diagram of a microfluidic device (330) including sensors (203) to detect a high change of on/off resistance, according to an example of the principles described herein. The microfluidic device (330) of FIG. 3B includes many elements that are included within the microfluidic device (300) of FIG. 3A. The sensors (203) of FIG. 3B include sensors pairs in a first sensor pair (203-1, 203-2) and a second sensor pair (203-3, 203-4) located within the fluidic channel (202). The sensor pairs (203) may be used to detect the location of the fluid (250) within the microfluidic device (330) at a higher resolution. For example, for the first pair of sensors (203-1, 203-2), due to the distance between the first pair of sensors (203-1, 203-2), if the control logic (120) determines that the fluid (250) has passed the first impedance sensor (203-1) but not the second impedance sensor (203-2) of the first pair of sensors (203-1, 203-2), then a higher resolution as to where the fluid (250) is within the microfluidic device (330) may be determined relative to instances where the more distance exists between the sensors (203-1, 203-2) of the first pair of sensors (203-1, 203-2). The same higher resolution may be obtained at the second pair of sensors (203-3, 203-4). Thus, the pairs of sensors (203) of FIG. 3B allow the microfluidic device (330) to control the location of the fluid (250) more precisely and with a higher resolution.

Further, when positioning fluid within the passageways of the microfluidic device (330), the pairs may be used as follows. As to the first pair of sensors (203-1, 203-2), the fluid may be detected by the first impedance sensor (203-1) as the control logic (120) sends signals to the first impedance sensor (203-1) and the second impedance sensor (203-2) to detect the fluid. The control logic (120) may also activate the first pump device (122-1) to increase a negative pressure on the fluid to pull the fluid back upstream in response to a detection of the fluid by the second impedance sensor (203-2). If the fluid is pulled by the first pump device (122-1) too far upstream such that the edge of the fluid passes the first impedance sensor (203-1) as well, the control logic (120) may instruct the first pump device (122-1) to reduce the negative pressure exerted on the fluid. In this manner, the edge of the fluid may be maintained at the position between the first impedance sensor (203-1) and the second impedance sensor (203-2). This provides the microfluidic device (330) with the ability to place the edge of the fluid at a very specific position based on the distance between the first impedance sensor (203-1) and the second impedance sensor (203-2). The closer the first impedance sensor (203-1) and the second impedance sensor (203-2) are to one another, the more precise the positioning of the fluid may be.

FIG. 3C is a block diagram of a microfluidic device (360) including sensors (203) to detect a flow rate, according to an example of the principles described herein. The microfluidic device (360) of FIG. 3C includes many elements that are included within the microfluidic device (300) of FIG. 3A. In some examples, it may be useful to determine how fast the fluid passively or actively travels through a passageway of the microfluidic device (360). The array of sensors (203) depicted in FIG. 3C may be located a predetermined distance between each sensor (203), and the control logic (120) may use a clock signal or other timing device to determine the flow rate of the fluid (250) through, for example, the fluidic channel (202) as well as changes in the flow rate of the fluid (250). For example, as the fluid (250) passes sensors (203-1, 203-2, 203-3, 203-4, 203-5, 203-6) in turn, the time the fluid (250) would take to do so may be used to determine the flow rate which may be measured as a volume of the fluid (250) that flows through the measured passageway of the microfluidic device (360) per unit of time and may be expressed as follows:

$$Q = \frac{dV}{dt} \qquad Eq . 1$$

where the flow rate “Q” is equivalent to the change in volume (dV) per change in time (dt).

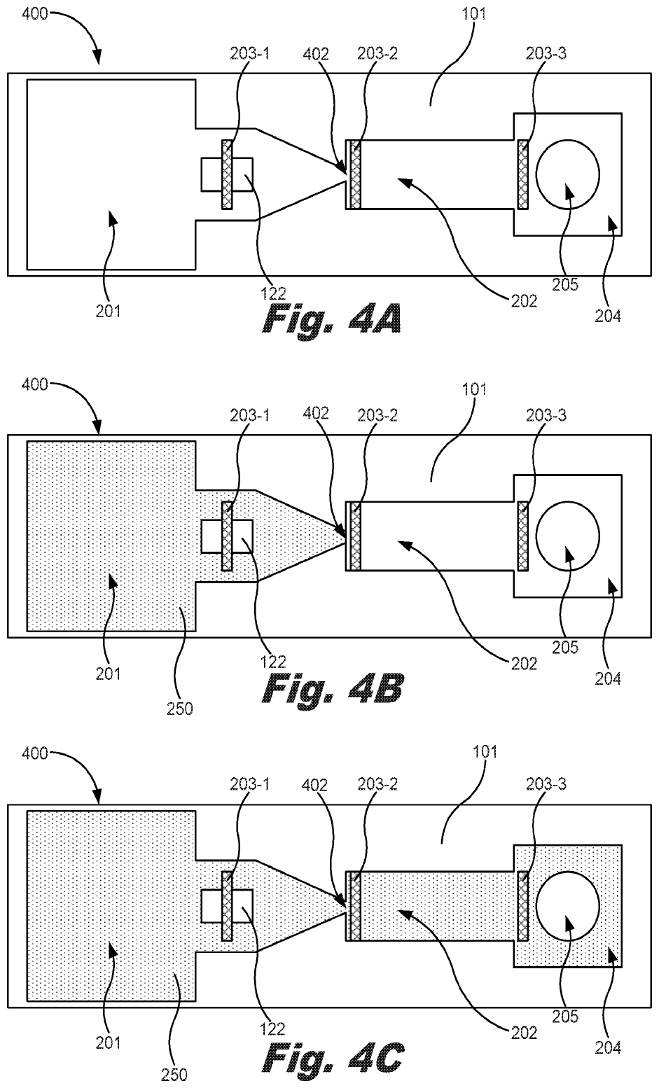

FIGS. 4A through 4C are block diagrams of a microfluidic device (400) depicting a fluid at various locations within a passageway, according to an example of the principles described herein. The microfluidic device (400) of FIGS. 4A through 4C includes many elements that are included within the microfluidic device (200) of FIGS. 2A through 2C and 3A through 3C. The example of FIGS. 4A through 4C include at least one pump device (122) to actively force the fluid (250) through the passageways of the microfluidic device (400) and at least one capillary break (402) to allow a discrete portion or amount of the fluid (250) to be drawn from a first passageway into another passageway.

The pump devices (122) described herein may include, for example, inertial pumps that include thermal resistive elements or piezoelectric elements, or external pump devices that are fluidically coupled to an end of the passageway to create a positive or negative pressure within the passageways to move the fluid through the passageways. The pump devices (122) may be electrically and communicatively coupled to the control logic (120) such that the control logic (120) may actuate the pump devices (122) when the fluid (250) is to be either restricted from moving within the passageways of the microfluidic device (400) or caused to move further into the passageways of the microfluidic device (400).

The capillary break (402) serves to allow a discrete portion or amount of the fluid (250) to be drawn from the reservoir (201) to the fluidic channel (202). In one example, the capillary breaks (402) described herein are formed and dimensioned to allow for at least as small as a 1 pL resolution metering of fluid (250). In other words, the fluid (250) may be drawn through the capillary break (402) at a volume of at least as small of as 1 pL. The capillary break (402) may be formed by decreasing the dimensions of the fluidic channel (202) to form a smaller orifice that serves to preclude movement of the fluid (250) out of the reservoir (201) and into the fluidic channel (202). An amount of the fluid (250) may be moved from the reservoir (201) and into the fluidic channel (202) through actuation of the pump device (401) that allows the fluid (250) to overcome the restraining forces provided by the capillary break (402) such that an amount of the fluid (250) enters the fluidic channel (202). In one example, the pump device (122) may be activated by the control logic (120) to meter an amount of the fluid (250) through the capillary break (402).

A first impedance sensor (203-1) may be located in the microfluidic device (400) of FIGS. 4A through 4C on or at least juxtaposition to the pump device (122) so that the control logic (120) may know when the fluid (250) has reached the pump device (122) based on the impedance value detected at the first impedance sensor (203-1). In this manner, the pump device (122) may be activated when fluid (250) is present around the pump device (122). The impedance sensors (203) of FIGS. 4A through 4C may function in a similar manner as described in connection with FIGS. 1 through 3C in order to position the edge of the fluid at a position within the passageways of the microfluidic device (400) precisely and accurately using the feedback provided by the impedance sensors (203), the control logic (120), and the pump devices (122).

The remainder of the impedance sensors (203-2, 203-3) of the microfluidic device (400) of FIGS. 4A through 4C function in a similar manner as described above in connection with the sensors (203-1, 203-2) described herein in connection with FIGS. 2A through 2C. Specifically, the sensors (203-2, 203-3) of the microfluidic device (400) may work singularly by providing impedance values to the control logic (120) independent of one another, and together to determine the location of the fluid (250) through their respectively detected impedance values and the differential between the two detected values.

Also, the second impedance sensor (203-2) may be used to determine when an amount of the fluid (250) has been metered from the capillary break (402). This information may be used by the control logic (120) to confirm that the pump device (122) has been activated to successfully meter the fluid (250) through the capillary break (402).

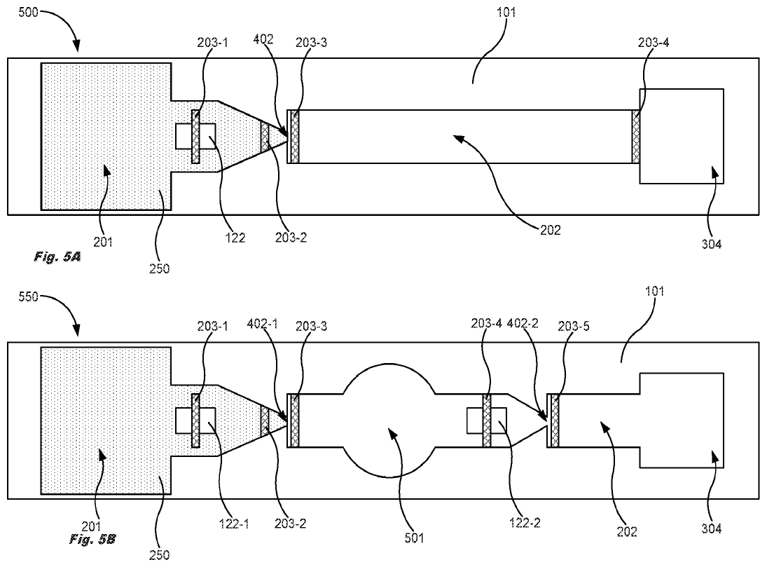

FIG. 5A is a block diagram of a microfluidic device (500) including sensors to detect single, dual, or differential impedance sense, according to an example of the principles described herein. The microfluidic device (500) of FIG. 5A may include a terminating chamber (304) as similarly described herein in connection with FIGS. 3A through 3C.

Further, the second impedance sensor (203-2) of the microfluidic device (500) may be located juxtaposition to the capillary break (402) and downstream from the pump device (122). This placement of the second impedance sensor (203-2) allows for the control logic (120) to determine if the fluid is present at the orifice of the capillary break (402) so that the pump device (122) may be activated to meter the fluid (250) into the fluidic channel (202).

Further, each of the sensors (203) in any of the examples of the microfluidic device (100, 200, 300, 330, 360, 400, 500, 550, 600, 650) described herein may work independently as individual impedance sensors (203), together as dual sensors where the detection by one impedance sensor (203) but not by another impedance sensor indicates the position of the fluid (250), and in a differential manner where the different impedances sensed by at least two separate impedance sensors (203) indicates the position of the fluid (250).

FIG. 5B is a block diagram of a microfluidic device (550) including sensors (203) to detect a boundary of fluid within a passageway of the microfluidic device (550), according to an example of the principles described herein. The microfluidic device (550) includes many elements that are included within the microfluidic device (500) of FIG. 5A. The microfluidic device (550) of FIG. 5B may further include a micro-reaction (μ-reaction) chamber (501) in which the fluid (250) is allowed to react. In one example, the μ-reaction chamber (501) may be a passageway within the microfluidic device (550) where the fluid (250) is allowed to remain for a period of time. In another example, the μ-reaction chamber (501) may be a passageway within the microfluidic device (550) where the fluid (250) is reacted with another fluid or a chemical already present within the μ-reaction chamber (501) may react with the fluid (250). Still further, the μ-reaction chamber (501) may be a passageway within the microfluidic device (550) where the fluid (250) is subjected to a physical change such as changing the fluid's (250) temperature through the use of a cooling or heating device, mixing of the fluid (250), exposure of the fluid (250) an electromagnetic field, other physical processes or combinations thereof. Even still further, the μ-reaction chamber (501) may be a passageway within the microfluidic device (550) where the fluid (250) is subjected to a combination of the above-described chemical and physical processes. In this manner, the μ-reaction chamber (501) causes the microfluidic device (550) to serve as a lab-on-chip device where the fluid (250) is subjected to chemical and physical processes, and characteristics of the processed fluid (250) may be measured. The fluid may be restricted by the first pump device (122-1) and first capillary break (402-1) using the feedback from the second impedance sensor (203-2) and the second impedance sensor (203-3) in order to ensure that the fluid does not enter the μ-reaction chamber (501) until the fluid is to be reacted within the μ-reaction chamber (501).

The microfluidic device (550) of FIG. 5B also includes a second pump device (401-2) and a second capillary break (402-2) in addition to a first pump device (401-1) and a first capillary break (402-1). The second pump (122-2) and second capillary break (402-2) may serve to assist in retaining the fluid (250) within the μ-reaction chamber (501) so that the fluid (250) may undergo the chemical and physical processes described herein without draining to the terminating chamber (304). In this example, the second pump device (122-2) may be activated by the control logic (120) in response to an impedance signal from the fifth impedance sensor (203-5) indicating that the fluid has passed through the second capillary break (402-2). Similarly, the second pump device (122-2) may be activated by the control logic (120) in response to an impedance signal from the fourth impedance sensor (203-4) indicating that the fluid has passed the fourth impedance sensor (203-4). Further, the second pump device (401-2) may be activated by the control logic (120) to force a processed fluid (250) from the μ-reaction chamber (501) and into the fluidic channel (202) and terminating chamber (304) after, for example, the characteristics of the processed fluid (250) are measured.

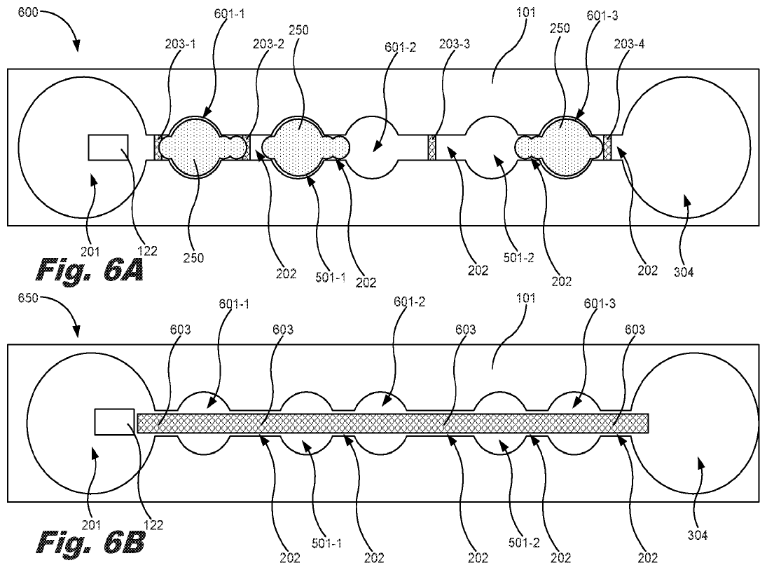

FIG. 6A is a block diagram of a microfluidic device (600), according to an example of the principles described herein. The microfluidic device (600) includes many elements that are included within the microfluidic devices (100, 200, 300, 330, 360, 400, 500, 550) described herein. Further, the microfluidic device (600) of FIG. 6A may include at least one staging chamber (601-1, 601-2, 601-3, collectively referred to herein as 601). The staging chambers (601) may be defined in the die (101) before a respective μ-reaction chamber (501-1, 501-2, collectively referred to herein as 501) and may be separated from its respective μ-reaction chamber (501-1, 501-2) by a fluidic channel (202).

The fluidic channels (202) that separate the staging chambers (601) and the μ-reaction chambers (501) may each include an impedance sensor (203-2, 203-3) that is used to determine if a volume of the fluid (250) has reached the location of the respective impedance sensor (203-2, 203-3). This is helpful in providing feedback from the impedance sensor (203-2, 203-3) regarding the position of the fluid (150) to the control logic (120), and allowing the control logic (120) to activate a pump device (122) or an external pump device based on the feedback. Specifically, the pump device (122) or external pump device may be activated by the control logic (120) to create a pressure differential in order to retain the fluid (250) at a specific point within the microfluidic device (600).

Specifically, the pump device (122) or external pump device may be activated by the control logic (120) to create a pressure differential in order to move the fluid (250) within the passageways of the microfluidic device (600). In the examples described herein, the fluid (250) may be retained at a specific point within a staging chamber (601), upstream from the associated impedance sensor (203), and not flowing into the μ-reaction chamber (501). For example, a pump device (122) or external pump device may be included in the microfluidic device (600) and may be activated to retain the fluid (250) within the first staging chamber (601-1) without passing the second impedance sensor (203-2) and into the first μ-reaction chamber (501-1). This may be achieved by the control logic (120) causing the second impedance sensor (203-2) to sense the impedance at the second impedance sensor (203-2) to determine if the fluid has flowed past the second impedance sensor (203-2). If the fluid has touched or passed the second impedance sensor (203-2), then the control logic (120) may activate the pump device (122) or external pump device to cause the fluid to move back upstream into the first staging chamber (601-1) and upstream from the second impedance sensor (203-2). If it is desired that the fluid should be moved into the first μ-reaction chamber (501-1) from the first staging chamber (601-1), then the control logic (120) may either cause the pump device (122) or external pump device to reduce or remove the differential pressure to allow the fluid (250) to flow into the first μ-reaction chamber (501-1) through capillary forces, or may cause the pump device (122) or external pump device to provide a downstream differential pressure to force the fluid (250) to flow into the first μ-reaction chamber (501-1). The fourth impedance sensor (203-4) may be used in a manner similar to the uses described herein for the second impedance sensor (203-2) and the third impedance sensor (203-3) when it is desired that the fluid (250) is to either be kept from entering or should be allowed to enter the terminating chamber (304).

FIG. 6B is a block diagram of a microfluidic device (650) including an extended sensor (603), according to an example of the principles described herein, according to an example of the principles described herein. The microfluidic device (650) includes many elements that are included within the microfluidic devices (100, 200, 300, 330, 360, 400, 500, 550, 600) described herein. Further, the microfluidic device (650) includes the extended sensor (603). In the example of FIG. 6B, instead of multiple “point” impedance sensors (203) along the length of the microfluidic device (650) and within the various passageways between the reservoir (201) and nozzle chamber (204) or terminating chamber (304), the impedance sensor (603) may be a longer sensor that extends, for example, through a plurality of passageways of the microfluidic device (650) such as a staging chamber (601), a μ-reaction chamber (501), a fluidic channel (202), a reservoir (201), a nozzle chamber (204) or terminating chamber (304), and combinations thereof. In this example, the impedance sensor (603) may include a conductive plate of an aspect ratio similar to the passageways such as the fluidic channel (202). The control logic (120) may activate the impedance sensor (603) to receive a single measurement. This single measurement may be an analog signal that correlates to how much of the passageways are filled with the fluid (250). In this manner, the extended impedance sensor (603) may be used to retain the edge of the fluid at a specific location within the passageways of the microfluidic device (650) by providing an analog signal to the control logic (120) that, in turn, may activate the pump device (122) to increase a positive or negative pressure on the fluid to move the fluid downstream or upstream based on the processes being performed on and measurements to the fluid. The extended impedance sensor (603) may provide for a simpler microfluidic device (650) that is easier to manufacture due to the single circuit created between the control logic (120) and the impedance sensor (603). Further, in some instances mismatches and electrical parasitics that may exist between a plurality of impedance sensors (203) as depicted in other examples herein is eliminated.

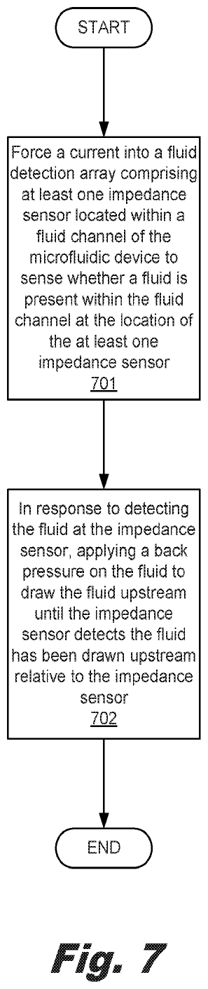

FIG. 7 is a flowchart showing a method (700) of controlling movement of a fluid within a microfluidic device (100, 200, 300, 330, 360, 400, 500, 550, 600, 650, collectively referred to herein as 100), according to an example of the principles described herein. The method (700) may include forcing (block 701) a current into a fluid detection array including at least one impedance sensor (103, 203, 603, collectively referred to herein as 103) located within a fluid channel (102, 202, collectively referred to herein as 102) of the microfluidic device (100) to sense whether a fluid (250) is present within the fluid channel at the location of the at least one impedance sensor (103). The fluid detection array may include any number of impedance sensors (103). The passageway may include any architecture defined within the die (101) of the microfluidic device (100) described herein including the fluidic channels (102), the reservoir (201), the nozzle chamber (204), the nozzle (205), the terminating chamber (304), the capillary break (402), the μ-reaction chamber (501), staging chamber (601), other architecture elements, and combinations thereof. At least one impedance sensor (103) is located within at least one passageway of the microfluidic device (100).

The method (700) may also include, in response to detecting the fluid (250) at the impedance sensor (103), applying (block 702) a back pressure on the fluid (250) to draw the fluid (250) upstream until the impedance sensor (103) detects the fluid (250) has been drawn upstream relative to the impedance sensor (103). The back pressure may be supplied by a pump device (122). The control logic (120) activates at least one impedance sensor (103) to detect the impedance of the fluid (i.e., air or non-air fluid) at the location of the impedance sensor (103), and receives from the impedance sensor (103) an impedance value that defines whether the fluid (250) exists at that impedance sensor (103).

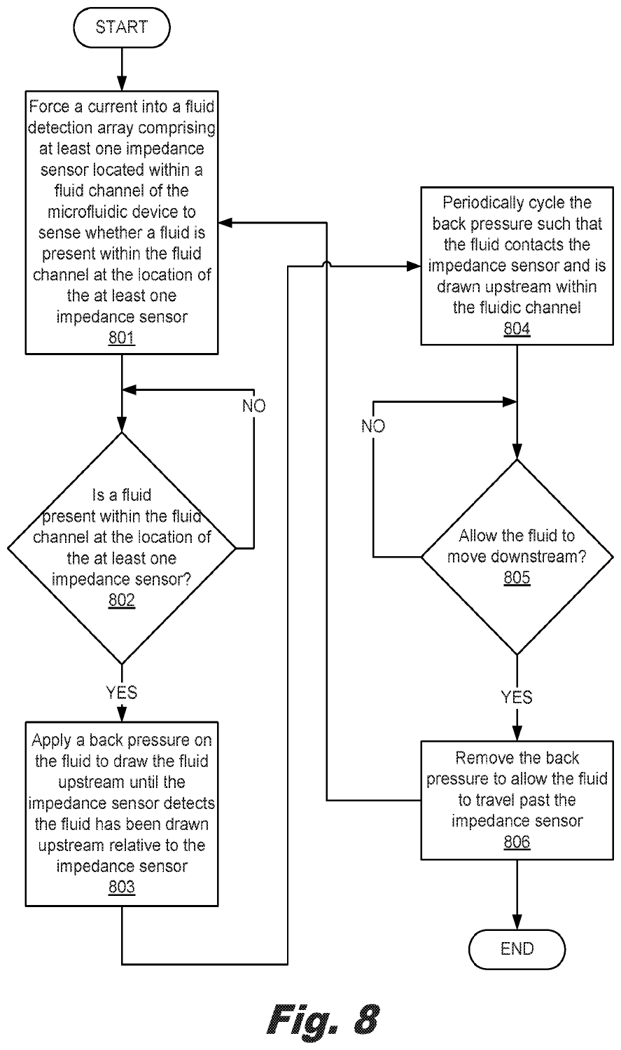

FIG. 8 is a flowchart showing a method (800) of controlling movement of a fluid within a microfluidic device, according to an example of the principles described herein. The method (800) may include forcing (block 801) a current into a fluid detection array including at least one impedance sensor (103, 203, 603, collectively referred to herein as 103) located within a fluid channel (102, 202, collectively referred to herein as 102) of the microfluidic device (100) to sense whether a fluid (250) is present within the fluid channel at the location of the at least one impedance sensor (103).

At block 802, is may be determined whether a fluid is present in the passageway such as a fluid channel (102) at the location of the at least one impedance sensor (103). In response to a determination that the fluid is not present in the passageway (block 802, determination NO), the method (800) may loop back to the outset of block 802 so that the impedance is continuously monitored and sensed to determine when the fluid is present at the impedance sensor (103).

In response to a determination that the fluid is present in the passageway (block 802, determination YES), the method (800) may include applying (block 803) a back pressure on the fluid (250) or increasing an already existing backpressure to draw the fluid (250) upstream until the impedance sensor (103) detects the fluid has been drawn upstream relative to the impedance sensor (103).

The method (800) may also include periodically cycling (block 804) the back pressure such that the fluid (250) contacts the impedance sensor (103) and is drawn upstream within the fluidic channel relative to the impedance sensor (103). A determination (block 805) may be made as to whether the fluid (250) should be allowed to move downstream. In response to a determination that the fluid (250) is not to be allowed to move downstream (block 804, determination NO), the method (800) may loop back to the outset of block 805 so that the when the fluid (250) is to be allowed to move downstream when appropriate for the processing and measuring of the fluid (250).

In response to a determination that the fluid (250) is to be allowed to move downstream (block 804, determination YES), the control logic (120) may instruct the pump device (122) to reduce or remove (block 806) the back pressure to allow the fluid (250) to travel past the impedance sensor (130). The method (800) may be performed for any number of iterations as indicated by the arrow returning back to block 801. However, the method (800) may terminate after block 806. Processing the fluid (250) within the microfluidic device (100) may include detecting any chemical or physical characteristic of the fluid (250), subjecting the fluid (250) to a chemical or physical process as described herein, or combinations thereof.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the control logic (120) of the microfluidic device (100) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a microfluidic device that uses impedance sensors to set backpressure within the microfluidic device. The microfluidic device may include a fluid channel defined in a substrate, an impedance sensor positioned within the fluid channel, and control logic. The control logic may force a current into the impedance sensor to sense an impedance at the location of the impedance sensor, the sensed impedance defining whether the fluid within the fluid channel is at the location of the impedance sensor, and instruct a pump device to apply a back pressure on the fluid to maintain the fluid upstream from the impedance sensor in response to a determination that the sensed impedance indicates that the fluid is located at the location of the impedance sensor.

The microfluidic device provides positive in-situ confirmation of proper fluidic backpressure adjustment for positioning of fluids within the microfluidic device. Further, the microfluidic device is easily integrated in a lab-on-chip (LOC) die. Still further, the microfluid devices described herein may utilize on-die signal conditioning or an electrode transmitting a signal to an off-die system.

The preceding description has been presented to illustrate and describe examples of the principles described. This description is not intended to be exhaustive or to limit these principles to any precise form disclosed. Many modifications and variations are possible in light of the above teaching.

What is claimed is:

1. A microfluidic device, comprising:
a fluid channel defined in a substrate;
an impedance sensor positioned within the fluid channel; and
control logic to:
force a current into the impedance sensor to sense an impedance at the location of the impedance sensor, the sensed impedance defining whether the fluid within the fluid channel is at the location of the impedance sensor; and
instruct a pump device to apply a back pressure on the fluid to maintain the fluid upstream from the impedance sensor in response to a determination that the sensed impedance indicates that the fluid is located at the location of the impedance sensor.

2. The microfluidic device of claim 1, wherein the impedance sensor comprises:
a first impedance sensor located at a first location within the fluid channel of the microfluidic device; and
a second impedance sensor located at a second location within the fluid channel downstream relative to the first impedance sensor,
wherein the control logic instructs the pump device to allow the fluid to move past the first impedance sensor but not past the second impedance sensor based on the detection of the fluid by the first impedance sensor and the second impedance sensor.

3. The microfluidic device of claim 1, wherein the impedance sensor comprises a single impedance sensor comprising a conductive plate with a length of at least a portion of the fluid channel, and wherein the single impedance sensor, when actuated, provides an analog signal that correlates with an amount of fluid within the fluid channel, the amount of fluid defining the location within the fluid channel at which the fluid is present.

4. The microfluidic device of claim 1, wherein the control logic instructs the pump device to draw the fluid upstream within the fluid channel until the sensed impedance of the impedance sensor indicates that the fluid is not in contact with the impedance sensor and is upstream from the impedance sensor.

5. The microfluidic device of claim 1, wherein the control logic continually monitors the sensed impedance at the impedance sensor to determine if the sensed impedance at the impedance sensor has changed.

6. The microfluidic device of claim 1, wherein the control logic periodically cycles the backpressure provided by the pump device such that the fluid contacts the impedance sensor and drawing the fluid upstream within the fluidic channel.

7. A system for applying back pressure within a microfluidic device, comprising:
a fluid detection array comprising at least one impedance sensor located within a fluid channel of the microfluidic device;
a pump device to move the fluid within the fluid channel; and
control logic to:
force a current into the impedance sensor to sense an impedance at the location of the impedance sensor, the sensed impedance defining whether the fluid within the fluid channel is at the location of the impedance sensor; and
instruct the pump device to apply a back pressure on the fluid to maintain the fluid upstream from the impedance sensor in response to a determination that the sensed impedance indicates that the fluid is located at the location of the impedance sensor.

8. The system of claim 7, wherein the fluid detection array further comprises:
a first impedance sensor located at a first location within the fluid channel of the microfluidic device; and
a second impedance sensor located at a second position within the fluid channel downstream relative to the first impedance sensor,
wherein the control logic instructs the pump device to allow the fluid to move past the first impedance sensor but not past the second impedance sensor based on the detection of the fluid by the first impedance sensor and the second impedance sensor.

9. The system of claim 7, wherein the impedance sensor comprises a single impedance sensor comprising a conductive plate with an aspect ratio of the fluid channel, and wherein the single impedance sensor, when actuated, provides an analog signal that correlates with an amount of fluid within the fluid channel, the amount of fluid defining the location within the fluid channel at which the fluid is present.

10. The system of claim 7, wherein the control logic, with the pump device, draws the fluid upstream within the fluid channel until the sensed impedance of the impedance sensor indicates that the fluid is not in contact with the impedance sensor and is upstream from the impedance sensor.

11. The system of claim 7, wherein the control logic continually monitors the sensed impedance at the impedance sensor to determine if the sensed impedance at the impedance sensor has changed.

12. The system of claim 7, wherein the control logic periodically cycles the backpressure provided by the pump device such that the fluid contacts the impedance sensor and drawing the fluid upstream within the fluidic channel.

13. A method of controlling movement of a fluid within a microfluidic device, comprising:
forcing a current into a fluid detection array comprising at least one impedance sensor located within a fluid channel of the microfluidic device to sense whether a fluid is present within the fluid channel at the location of the at least one impedance sensor; and
in response to detecting the fluid at the impedance sensor, applying a back pressure on the fluid to draw the fluid upstream until the impedance sensor detects the fluid has been drawn upstream relative to the impedance sensor.

14. The method of claim 13, further comprising periodically cycling the backpressure such that the fluid contacts the impedance sensor and is drawn upstream within the fluidic channel.

15. The method of claim 13, further comprising:
in response to an instruction to allow the fluid to move downstream relative to the impedance sensor, removing the backpressure to allow the fluid to travel past the impedance sensor; and
detecting with the impedance sensor, whether the fluid is present within the fluid channel at the location of the impedance sensor.
